(19) United States
(12) Patent Application Publication
(10) Pub. No.: US 2008/0038470 A1
(43) Pub. Date: Feb. 14, 2008

(54) SURFACE COATING COMPOSITIONS

(75) Inventors: Graham Hagens, Toronto (CA); Doug Bilbija, Oakville (CA); Jeremy Hagens, Hamilton (CA)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: CANTECH INDUSTRIAL RESEARCH CORPORATION, Toronto (CA)

(21) Appl. No.: 11/837,644

(22) Filed: Aug. 13, 2007

Related U.S. Application Data
(60) Provisional application No. 60/836,979, filed on Aug. 11, 2006.

(51) Int. Cl. C08J 3/05; B05D 1/02; B05D 3/10

(52) U.S. Cl. 427/340; 106/238

(57) ABSTRACT

Protective coatings, in particular for the purpose of shielding and waterproofing buildings and engineered outdoor structures are based on mixtures of polymer modified tall oil, in particular mixtures of an aqueous emulsion of tall oil with an aqueous polymeric latex. Waterproofing/coating compositions according to the invention may be made as a two-component sprayable system comprising a first part which is a mixture of a tall oil emulsion and a polymeric latex and a second part which is an aqueous solution of an effective curing agent.

### FIELD OF THE INVENTION

The present invention is directed to pitch-type waterproofing compositions based on polymer-modified tall oil. More particularly, the present invention is concerned with polymer modified tall oil waterproof compositions that are used for the purpose of shielding buildings and structures for engineering works against water, moisture and rust, or the filling of cavities or other purposes.

More particularly still, the present invention relates to polymer modified tall oil type of waterproofing compositions that can be instantaneously coagulated by a normal temperature spray waterproofing method in order to form stable yet tough weatherproof, waterproof and chemically resistant membranes.

The present invention is also directed to the use of tall oil emulsions to extend and improve other film forming polymers, such as polyacrylates, to confer flexibility and resistance to UV degradation.

### PRIOR ART

The following United States patents disclose a variety of known surface coating compositions currently in use for like applications as the present invention. The disclosure of each of the below-listed US patent documents is incorporated herein by reference for its description of protective waterproofing coating compositions.

### U.S. Patent Documents

| | | |
|---|---|---|
| 3,785,852 | January 1974 | Schleidt |
| 4,287,242 | September 1981 | Monden, et al. |
| 4,437,896 | March 1984 | Partanen |
| 4,822,425 | April, 1989 | Burch |
| 5,671,889 | September 1997 | Petty |
| 5,674,313 | October 1997 | Aoyama, et al. |
| 5,763,014 | June 1998 | Pickett |
| 5,895,347 | April 1999 | Doyle |

### BACKGROUND OF THE INVENTION

(a) Asphalt-Based Surface Coating Compositions

Combinations of asphaltic (or bituminous) emulsions with a variety of water soluble polymers, and polymeric emulsions are well known in the art of surface coating for protecting various types of surfaces from the elements. Such compositions offer a number of advantages in terms of cost and safety, being water based, non-flammable and low in volatile organic compounds. The formulations used commercially may be applied by brushing, rolling, trowelling etc., after which the surface film may be air-dried at ambient temperatures, or by accelerated processes by application of heat. Alternatively such coatings may be applied by means of a two-part spray apparatus by which technique the composition sets and cures very rapidly.

Schleidt (1974) describes a method of applying a bituminous-rubber membrane composition by simultaneously spraying the liquid emulsion composition and a coagulant along spray paths which converge so that the composition and coagulant mix thoroughly before contacting the surface being treated. This invention is said to find particular utility in roofing applications in addition to sound insulating, vibration dampening and vehicle undercoating.

Schleidt was intended as an improvement of other known asphalt emulsion-rubber latex compositions which had inadvertently been applied by brush, troweling or by spraying. Curing was accomplished merely by air drying, which procedure was time consuming. It was found that by directing separate streams of chemical coagulant and bituminous emulsion-rubber latex composition along paths which intersect each other at a sufficient distance from the surface to permit thorough comingling of the emulsion-latex composition with the coagulant, the bituminous emulsion and the rubber latex are substantially broken by chemical action of the coagulant, before the materials contact the surface which effected very rapid setting and curing of the membrane composition.

A wide variety of bituminous materials are mentioned in Scheildt where it is recognized that coal-derived tars and pitches, shale oil residues as well as compatible mixtures of the foregoing might be used. Suitable emulsifying agents and methods of emulsification for forming oil-in-water emulsions of bituminous materials are well known to those skilled in the art. Representative examples include alkali soaps, resin soaps, rosin soaps, casein, proteins and the like. The gelatinizing agent recommended for this application derived from a family of polyvalent metals and their salts, calcium chloride being preferred for reason of cost, safety and availability.

Similarly Monden et al. (1981) describes a spray-coating process which comprises spraying a rubber-asphalt anionic and a polyvalent metal salt simultaneously by means of separate airless type spraying machines to continuously contact and mix said emulsion with said aqueous solution in the space between the spraying machine and the surface of a substrate to be coated and on the substrate surface, thereby forming a rubber-asphalt solid layer on the substrate surface. By this process, a rubber-asphalt solid layer having a thickness of 4 mm or more and having a water-proof, moisture-proof or gas-proof characteristics can be formed rapidly on the substrate surface.

Monden also claims advantages over those methods of brushing or trowelling for which a long period of time is necessary for drying thick applications, and which also tend to form cracks. These advantages are said to be accomplished by spraying a rubber-asphalt emulsion having a total solid content of 700% by weight on more and a 1-15% by weight aqueous solution of a polyvalent metal salt almost simultaneously from separate airless type spraying machines to continuously contact and mixing said emulsion with said aqueous solution in the space between the spraying machine and the surface of a substrate to be coated and on the substrate surface, thereby forming a rubber-asphalt solid layer on the substrate surface.

According to both Monden's and Schleidt's disclosures the rubber-asphalt emulsion used in this invention is required to be anionic, so that the surfactant employed therein is mainly an anionic one. The elastomeric latexes usable in the rubber-asphalt include natural rubber, styrene-butadiene rubber, butyl rubber, polybutadiene rubber, polyisoprene rubber, chloroprene rubber and the like, and it being preferable that said rubber comprises the styrene-butadiene rubber or modified styrene-butadiene rubber as a main constituent from the viewpoint of performances of rubber-asphalt solid layer and economy.

Pickett (1998) discloses a liquid applied waterproofing formulation system comprises separate formulation components A and B which are transportable to the application site in separate containers but combinable at the site to form a blend, preferably a water-in-oil blend, which solidifies into a continuous membrane having hydrostatic head resistance. Component A is an aqueous latex of a natural or synthetic rubber. Component B is an oil carrier in which is dispersed a vulcanizing agent operative to cure the rubber and a hygroscopic agent operative to chemically bind the water in component A. Methods for waterproofing, employing the formulation system, are also disclosed.

For the purpose of alleviating certain problems associated with the gellation of asphaltic-rubber latexes using polyvalent inorganic salts, Aoyama et al. (1997) describes a method of generating contiguous rubberized asphaltic membranes by combining a mixture or cationic asphalt and rubber emulsions with anionic curing agents such as aliphatic and aromatic sulfonates. According to these inventors this process results in the formation of membranes with improved surface adhesion. By elimination of certain inorganic anions such as chlorides, corrosion resistance is also said to be improved. The instantaneously coagulating compositions so described and intended for use in waterproofing, moisture-proofing and rustproofing. The rubber materials usable in the present invention include natural rubber, gutta-percha, cyclized rubber, styrene-butadiene rubber, styrene-isoprene rubber, polyisoprene rubber, butadiene rubber, chloroprene rubber, butyl rubber, halogenated butyl rubber, chlorinated polyethylene, chlorosulfonated polyethylene rubber, ethylene-propylene rubber, EPT rubber, olefin rubber, styrene-butadiene block polymer rubber, styrene-isoprene block polymer rubber, etc.

In none of the prior art directed to asphalt-based coating compositions such as those described above is there any suggestion of using crude tall oil derivatives, such as tall oil pitch.

Although those prior known compositions of the above type have achieved a measure of commercial success, it is well known to those skilled in the art of waterproofing and decorating buildings and other structures with coating formed from them that they nevertheless suffer from a number of significant disadvantages. The first such is that asphaltic compounds are intensely black in color, so that it is not possible to lighten the texture without adding such quantities of pigment that the physical properties of the coating is undermined.

The alternative of painting these coatings with a further coloring coating of some kind, adds one more step and additional cost to the process.

A second disadvantage is that known asphaltic-elastomeric compositions exhibit inferior adhesion to a variety of synthetic polymers and metals. Thus, they have been found not to adhere particularly well to such coatings to ethylene propylene diene monomer (EPDM), polyethylene, polypropylene and various similar saturated polymeric films. Likewise they provide poor adhesion to certain common metallic surfaces such as copper and aluminum.

(b) Tall Oil Emulsions Coatings

An alternative known methodology for coating outdoor surfaces is the art of manufacture and application of tall oil emulsions. Tall oil is a liquid resinous material obtained as a by-product during the digestion of wood chips during pulp and paper manufacture. Commercial tall oils comprise a complex mixture of fatty acids, rosin acids, sterols, higher alcohols, esters, waxes and hydrocarbons.

Crude tall oil (CTO) is commercially distilled into a family of distilled tall oil (DTO) materials, broadly divided into the categories of tall oil fatty acids and tall oil resin acids which find wide industrial usage as chemicals in lubricants, emulsifier soaps, adhesives and components in a wide range of specialty chemicals. The residue which remains at the bottom of the distillation tower after distillation is known as crude tall pitch (CTP).

As used hereinafter in the description and claims, “tall oil” refers collectively to CTO, DTO, CTP and blends thereof. “Emulsions” as used herein refers both to chemically stabilized dispersions of water insoluble liquids in water in which the water is the continuous phase (so-called oil in water emulsions), and to those in which the insoluble material is the continuous phase (so called water in oil emulsions).

Methods for of manufacturing both the asphaltic (here considered synonymous with “bituminous”) emulsions (a), and tall oil emulsions (b) are well known (Partanen 1984; Burch 1989; Doyle 1999). Both types of emulsion are commercially available from various suppliers having been prepared under acidic (cationic), alkaline (anionic) or neutral (nonionic) emulsification technologies.

Following emulsification using techniques known to the art, the resulting tall oil emulsions are typically prepared as compositions containing between 30 and 70% by weight (% w/w) solids, of which between about 1 and 2% w/w consists of emulsifiers and pH modifiers. A precise chemical description of the emulsions so derived is not usually possible because the tall oils generally consist of a complex mixture of linear, branched and cyclized (so-called tall oil fatty acids and rosin acids respectively), in addition to a variety of poorly characterized chemical species noted above.

Asphalt emulsions and tall oil emulsions both find a wide range of usage in similar fields of application, such as road and highway construction and maintenance, dust control, briquetting and binding etc. Both exhibit good thermoelastic flow properties, ease of handling, and provide good bonding and strength properties to a wide range of substrates such as aggregates.

Both asphalt emulsions and tall oil emulsions suffer, however, from a number of weaknesses which prevent their widespread usage in value added applications such as paints and specialty coatings. As noted above asphalt emulsions even when blended with polymeric additives are not available in any color other than black, and also exhibit less than satisfactory resistance to organic solvents. The tall oil emulsions presently available commercially are completely unsatisfactory for use as paints or surface coatings. Not only are the films formed from them very weak, but they are also extremely tacky.

In the course of searching for a method of improving the properties of polymer modified asphalt emulsions we discovered that certain blends of tall oil emulsions and polymers yielded products for coating surfaces, having very advantageous properties not hitherto described in the art.

### SUMMARY OF THE INVENTION

It is a principal objective of the present invention to replace the asphalt in coating compositions of the type (a) described above by tall oil, to overcome the aforementioned disadvantages of colour, poor adhesion to certain surfaces, etc.

It is a further objective of the present invention to provide coating formulations in which conventional film forming polymers such as acrylates are extended by the addition of tall oil to produce greater strength and solvent resistance than known emulsion-based surface coating compositions of the above type (b) compositions.

We have discovered that crude tall pitch (CTP) emulsions can advantageously replace asphalt emulsions in waterproofing membranes while enhancing existing properties and providing new properties such as the ability to take colour and improved resistance to chemical solvents. We have also found that tall oil emulsions may be used to extend and improve other film forming polymers such as acrylates, in particular to confer flexibility in outdoor applications, where neoprenes and SBR are relatively vulnerable to degradation by ultraviolet light.

### DETAILED DESCRIPTION OF THE INVENTION

The compositions herein described are formulated by combining various soluble polymers, or aqueous emulsions of polymers and co-polymers, including elastomers, with tall oil emulsions. In the course of investigating possible coating systems which might exhibit improved properties over the rubberized asphaltic compositions described above, it was discovered that mixtures of tall oil emulsions with polymeric elastomeric latexes allow improvements over asphaltic and bituminous emulsion based compositions.

The resulting products at least equal the performance properties of polymer modified asphalt emulsions, and are superior in a number of respects.

While the primary and most obvious advantage over the polymer modified asphaltic systems is the ability to formulate colorized compositions, we also discovered to our surprise that another significant advantage also exists, this being significantly improved resistance to organic solvents and oils. As is well known to those skilled in the art of bituminous compositions, one disadvantage inherent in asphaltic formulations, whether applied as emulsions or as hot melts, stem from the fact that they are rapidly dissolved by many commonly available organic compounds such as hydrocarbons, ketones, etc.

As illustrated in the Examples below, tall oil exhibits markedly superior resistance to many organic chemicals, which it imparts to the mixtures according to the invention. Moreover, like asphalt, tall oil is the byproduct of an industrial process and consequently is considerably lower in cost than many synthetic materials utilized for the manufacture of coating and waterproofing products.

However, individually asphalt and tall oil share another similarity in that without reinforcement with other materials such as polymers, their physical properties are inadequate for most practical coating and waterproofing applications, being generally too weak, soft and sticky for the end use required. Consequently most commercial coating opportunities for tall oil as such involve ‘low end’ applications such as dust control and non demanding highway applications such as road shoulder maintenance.

No formulations combining tall oil emulsions with polymer latexes of various kinds have previously been described in the art. As illustrated in the Examples below, we have discovered that substitution of asphaltic emulsions by those of tall oil emulsions in polymer modified compositions not only results in products with similar performance properties, but also yields certain novel advantages. In addition to the obvious advantage of being a clear material which can therefore be colorized by means of conventional used in the production of paint. Our modified tall oil compositions also exhibit superior resistance to organic solvents when compared with prior coatings based solely on bituminous emulsions.

We have also found that the properties and low cost of tall oil emulsions render them valuable as extenders for a wide range of polymers used in conventional paints and waterproofing compositions. This improvement may be realized whether the emulsifiers used to manufacture the tall oil emulsion are cationic, anionic or nonionic to suit the polymer system of interest. Depending on the emulsifier of choice therefore, tall oil emulsions may be used to improve the performance of a wide range of anionic polymeric latexes well known to the art of surface protection and waterproofing. Such latexes include dispersions of elastomers such as natural rubber, gutta-percha, styrene-butadiene rubber, styrene-isoprene rubber, polyisoprene, polybutadiene, polychloroprenes (Neoprenes), organic polysulfides, butyl rubber, halogenated butyl rubber, chlorinated polyethylene, chlorosulfonated polyethylene, ethylene-propylene rubber, butadiene acrylonitrile copolymers, and the like.

Another family of polymeric latexes in which the addition of tall oil emulsions may be advantageous is the wide range of non-elastomeric polymers with which the tall oil emulsions are compatible. In particular, we have found that the tall oil emulsions may be used as extenders for a wide range of water soluble dispersions known in the art of surface protection and water proofing. Within this family of products may be mentioned polyvinyl alcohol, polyvinyl acetate, polymethyl methacrylate, polyacrylic, ethylene-vinyl acetate copolymers, ethylene-acrylate copolymers and vinyl acetate-acrylate copolymers, etc. Although these polymer latexes are well known, and have been described for the coating and protection of a variety of surfaces, the advantageous combination with tall oil-emulsion has not previously been disclosed.

The Examples below of stable coatings according to the invention are not restrictive, but are illustrative of the potential range of application of tall oil emulsions in coating compositions. In effect, tall oil emulsions (whether derived from crude tall oil, distilled tall oil or tall oil pitch) may be used as a cost effective extender for a wide range of elastomeric and non-elastomeric polymers widely used in coating and waterproofing situations. In these coating compositions the weight ratio of tall oil to polymer may be between 10:90 and 95:5, depending upon the final properties desired.

Improvements in the cost performance of these systems can be realized with anionic, cationic or nonionic tall oil emulsions, all of which are commercially available, the choice of which to use being determined by the chemical composition of the polymer system of choice.

In the preferred embodiments specifically disclosed herein, the form of tall oil most advantageous to these application consists of either the anionic and nonionic emulsion of tall oil pitch, while the most advantageous latexes consist of polychloroprenes (family name Neoprene, DuPont-Dow Elastomers), and acrylics (family name Rohm and Haas). These groups represent a particularly advantageous combination because of the high strength and flexibility imparted by the Neoprenes, and the excellent adhesion and ultraviolet resistance provided by the acrylics. As will be appreciated by those skilled in the art of coating formulations, various blends of the preferred latexes can be utilized depending on preferred final properties desired.

Moreover these formulations are also amenable to useful modification by additives such as pigments, fillers and process aids known in the art of surface protection, waterproofing and painting. Thus, where exceptional weather resistance is required, this may be achieved by the addition of ultraviolet absorbers known to the art. Similarly, fire resistance can be improved by the incorporation of such chemicals and intumescent agents as are compatible with anionic and nonionic latex mixtures. Likewise, the formulations may be varied by the addition of viscosity modifiers such as thickeners, foam control agents, corrosion inhibitors and stabilizers as known to the art. The formulations may also be further built using insoluble fillers such as clays, ground crumb rubber, mica, polystyrene beads and the like known in the art of surface protection. The compositions may also include fibers. The fiber materials usable in the present invention include synthetic fibers such as glass fibers, rayon silk, vinylon, saran, polypropylene, polyester, polyamide and polyimide, carbon fibers, etc. In required, steel fibers may be used as well. Moreover since these compositions have as formed a light tan color, they may be readily colorized by addition of certain compatible pigments and pigment dispersions.

Compositions according to the invention may be applied to surfaces either by means of such common practices of wiping, brushing or spraying onto to the substrate. Of particular interest however was our determination by experiment that some compositions of the invention can be applied to surfaces by means of double spray systems in which the composition and a curing catalyst are admixed in the air. As discussed above such methods are known for the application of polymer modified asphaltic emulsions in which means the coating being applied sets almost instantly. For coatings according to the invention the mixture of tall oil emulsion and suitably chosen polymeric latex is sprayed through one nozzle of a two-part applicator, and a catalytic curing agent sprayed through the other. Again, this method is not generally applicable to tall oil emulsions manufactured using nonionic emulsifiers, it may be used successfully with either anionic or cationic tall oil emulsions.

The two-part application may be carried out using equipment and many of the curing agents described in prior art related to polymer modified bituminous emulsions. Accordingly, if the tall oil-latex combination is anionic in nature, the catalytic curing agent would typically consist of one or more of the soluble salts of polyvalent metals. If the tall oil-latex composition is cationic in nature, then suitable appropriate known anionic systems would be required.

For example, if a mixture of cationic tall oil emulsion and a cationic styrene butadiene latex were to be sprayed through one nozzle of the two part spray unit (as ‘Part A’), then ‘Part B’ to be sprayed through the other nozzle would be a solution of an anionic material, such as for example the sulfate of a long carbon chain hydrocarbon. A precise ratio of Parts A and B is determined which will ensure that the cationic and anionic components utilized set instantly. In the Example given below, the blended tall oil-polymer emulsion is anionic in nature, while the curing agent is calcium chloride.

In a preferred composition Part A would consist of a mixture of an anionic tall oil pitch emulsion, with Neoprene, acrylic and a styrene-butadiene elastomeric latex, while Part B would consist of the solution of calcium chloride. The preferred concentrations of the various ingredients and the ratio of the volumes of Parts A and B during application depend on the final properties desired, and the details shown in the Examples below are merely illustrative of the types of final properties which might be realized.

Although the polyvalent metal salt used as a coagulant is not critical, it must be readily soluble in water and excellent in ability to coagulate the emulsion. It is also desirable that this salt be relatively low in cost, and that it have low toxicity, since workers may become exposed to aerosols droplets of this agent during application procedures. For these reasons the range of preferred curing agents is generally limited to the chlorides, nitrates and soluble sulfates of the alkali earth metals calcium, magnesium and aluminum, or such mixed salts as iron alum, potassium alum and the like. In some situations however it may also be desirable to utilize certain inexpensive and non toxic organic cationic materials such as the inorganic salts of certain quaternary ammonium compounds as may be practical to use.

The two component procedure is strongly preferred over one component composition where the tall oil emulsions being used are anionic in nature, and derive from either crude or distilled tall oil. This is because the elevated pH in anionic systems results in conversion of the organic acids in CTO and DTO to soluble soaps which render the final composition unsuitable for any application involving exposure to water. The added advantage of the two part process particularly when CTO or DTO are employed is that the reaction products of the anionic emulsion (Part A) and the cationic catalyst (Part B) typically consist of insoluble soaps, most commonly of the alkali earth metals, which have high melting points and excellent bonding properties. Moreover since the preferred salts to be used as curing agents (e.g. CaCl₂, MgCl₂ or Al₂ (SO₄)₃) are relatively inexpensive, this procedure has the added advantage of reducing the overall cost of the application.

In the case of Part A being anionic in nature, and Part B being a soluble alkali earth salt, suitable compositions of sprayable consistency will contain from about 98 to about 65 wt % of a tall oil emulsion containing from about 40 to about 70 wt % solids; and from about 2 to about 35 wt % polymer latex containing from about 55 to about 65 wt % solids. The admixture of emulsion and latex is conveniently made by adding the smaller quantity of latex to the larger quantity of emulsion with stirring until homogeneity is obtained. A suitable coagulant can be prepared by forming from about a 3.0 to 32 wt % (i.e. saturated) solution of calcium chloride in water. This solution would then be sprayed at the rate of from about one-fifth to about one-fourth gallons per gallon of the tall oil/polymer emulsion blend.

Compositions herein disclosed exhibit superior properties to the asphaltic polymeric systems previously described, without sacrificing the primary advantages of these compositions. Thus the products here described have low cost, are non-toxic, non-flammable and contain no volatile organic compounds. As described in the Examples below, the results of this process are equal to, and in some ways remarkably superior to those processes heretofore described in the literature. The compositions will be further described in the Examples which follow.

### EXAMPLE 1

### Substitution of Asphalt by CTP

In order to demonstrate the value of substituting tall oil emulsions for asphalt, a selected number of polymer modified formulations were prepared and evaluated. The asphaltic emulsion used in this example was a 60% active anionic emulsion prepared from 52-28 performance grade asphalt using a proprietary anionic emulsifier (Lafarge Asphalt Engineering, Mississauga, Ontaria), while the 60% active anionic crude tall pitch emulsion was prepared for these experiments using a Rashig laboratory mill. These base emulsions were then blended with a number of commercial polymeric latexes in order to prepare the experimental formulations shown in Table 1. Aliquots of each were cast into a silicone coated paper and allowed to air cure at 20° C. and 50% RH for 3 days. The cured samples taken for testing were 80 mil (2 mm) thick. Tensile strength, elongation, durometer hardness results are shown in Table 2. Adhesion measurements were performed on samples cured onto clean steel plates.

TABLE 1
Compositions

| | | | | | base |
|---|---|---|---|---|---|
| | Base | | | Generic latex | emulsion/ |
| Formula # | emulsion | Latex | Supplier | composition | latex ratio |
| 1-1 | Asphalt | Butonal | BASF Canada | Styrene butadiene | 65/35 |
| | | NS 129 | | co-polymer | |
| 1-2 | CTP | Butonal | BASF Canada | Styrene butadiene | 65/35 |
| | | NS 129 | | co-polymer | |
| 1-3 | Asphalt | Styrez | Halltech Inc., | Polyacrylate | 80/20 |
| | | 2810 | Pointe-Claire | | |
| | | | PQ | | |
| 1-4 | CTP | Styrez | Halltech Inc., | Polyacrylate | 80/20 |
| | | 2810 | Pointe-Claire | | |
| | | | PQ | | |
| 1-5 | Asphalt | Neoprene | DuPont-Dow | Polychloroisoprene | 60/40 |
| | | 400 | elastomers | | |
| 1-6 | CTP | Neoprene | DuPont-Dow | Polychloroisoprene | 60/40 |
| | | 400 | elastomers | | |
| 1-7 | Asphalt | Neoprene | DuPont-Dow | Polychloroisoprene | 75/25 |
| | | 671A | elastomers | | |
| 1-8 | CTP | Neoprene | DuPont-Dow | Polychloroisoprene | 75/25 |
| | | 671A | elastomers | | |

TABLE 2

| | Tensile | | Durometer | Adhesion |
|---|---|---|---|---|
| Formula # | strength, psi | Elongation % | hardness | failure |
| 1-1 | 150 | 900 | 73 | Cohesive |
| 1-2 | 140 | 950 | 71 | Cohesive |
| 1-3 | 120 | 200 | 70 | Cohesive |
| 1-4 | 120 | 250 | 71 | Cohesive |
| 1-5 | 200 | 900 | 75 | Cohesive |
| 1-6 | 190 | 950 | 74 | Cohesive |
| 1-7 | 120 | 850 | 68 | Cohesive |
| 1-8 | 115 | 900 | 66 | Cohesive |

These performance results reveal CTP pitch to be a viable substitute for asphalt in a number of polymer modified compositions.

### EXAMPLE 2

### Colorized Coatings

In order to demonstrate some of the advantage utilizing CTP emulsions as extenders for polymers commonly used in the coating industry, a number of blends of CTP emulsions with various polymers, fillers and pigments commonly used in paint and coating compositions were prepared. It was found that the preferred pitch emulsions for optimal shelf life stability were those prepared using nonionic emulsifiers, and that the preferred fillers were those with low levels of calcium, such as aluminosilicates. The compositions shown in Table 3 were prepared in the laboratory using low shear mixing equipment. All the compositions shown were stable dispersions, the viscosities of which could be modified as required using commercial thickeners known in the art. Cast membranes were cured and evaluated for resistance to ultraviolet radiation using by subjecting them to 250 hours exposure in a weatherometer chamber.

In order to demonstrate the versatility of tall oil emulsions as extenders for a number of polymers used in coatings and paints, a series of compositions were prepared using some polymer dispersions commonly employed in industrial and residential coatings. In this series the formulas were prepared using an alcohol ethoxylate nonionic surfactant. The compositions shown were variations of three basic blends all of which were a 50/50 blend of a 500% CTP emulsion and one of three types of polymer:

Blend #1: Styrez 873, polyacrylonitrile (Halltech Inc., Pointe-Claire PQ),

Blend #2: BarrierPro DR 4555 modified polyacrylate (Dow Reichhold Specialty Latex, Research Triangle Park, NC)

Blend #3: Styrez 2810, polyacrylate (Halltech Inc., Pointe-Claire PQ).

To these were then added various pigments purchased from Rieger Flexo & Gravure (Downsview, Ontario), and optionally filled with aluminosilicate white filler (Huberfil 85, J.M. Huber Corporation). In each of the examples shown the level of pigment was 30%, when filler was included it was at the level of 20%. Some typical formulations and results are shown in Table 3.

TABLE 3

| | Blend | | Huberfil | Formula | Film | Weather |
|---|---|---|---|---|---|---|
| Formula | # | Pigment | 85 | stability | appearance | resistance |
| 3-1 | 1 | White | — | Excellent | Light tan | Poor |
| 3-2 | 2 | White | — | Good | Light tan | Poor |
| 3-3 | 3 | White | — | Good | Light tan | Good |
| 3-4 | 3 | White | 20% | Settling | Good | Excellent |
| 3-4 | 1 | Blue | — | Good | Good | Poor |
| 3-5 | 2 | Blue | — | Good | Good | Fair |
| 3-6 | 3 | Blue | — | Good | Good | Excellent |
| 3-7 | 1 | Red | | Good | Dull red | Poor |
| 3-8 | 2 | Red | | Good | Dull red | Fair |
| 3-9 | 3 | Red | | Good | Dull | Good |
| 3-10 | 3 | Red | 20% | Settling | Excellent | Excellent |

These examples are intended to illustrate the range of possibilities of using pitch emulsions as extenders for polymers commonly used in coating formulations. Note that the UV resistance is strongly affected by the polymer used.

### EXAMPLE 3

### Solvent Resistance

Polymer modified tall oil compositions are much more resistant to solvent attack than are those derived from asphalt. This phenomenon was demonstrated by immersing various combinations of asphalt, pitch and polymers in different solvents. The compositions used in the example are shown in Table 4 were prepared by hand blending a 60% asphalt emulsion (45 pen asphalt Lafarge Asphalt Engineering), with the latexes shown in the table in the ratio of 80/20 by weight. In these experiments cast, air cured membranes 20 mil (1 mm) thick were cut into 2″×1″ test strips and immersed in the solvent. Four different solvents were used: Mineral spirits; isopropyl alcohol (700%), Canola salad oil and xylene. Weight loss due to dissolution was determined by weight difference after the samples were fully dried.

TABLE 4
Compositions

| | Base | | | Generic latex |
|---|---|---|---|---|
| Formula # | emulsion | Latex | Supplier | composition |
| 4-1 | Asphalt | Tylac 873 | Dow- | Polyacrylonitrile |
| | | | Reichhold | |
| 4-2 | CTP | Tylac 873 | Dow- | Polyacrylonitrile |
| | | | Reichhold | |
| 4-3 | Asphalt | Styrez 8710 | Hallmark, | Polyacrylate |
| | | | Toronto | |
| 4-4 | CTP | Styrez 8710 | Hallmark, | Polyacrylate |
| | | | Toronto | |
| 4-5 | Asphalt | Neoprene | DuPont-Dow | Polychloroisoprene |
| | | 671A | elastomers | |
| 4-6 | CTP | Neoprene | DuPont-Dow | Polychloroisoprene |
| | | 671A | elastomers | |

TABLE 5
Comparison of asphalt and CTP acrylonitrile blends

| | | | Immersion | | Weight |
|---|---|---|---|---|---|
| Formula # | Composition | Solvent | time | | loss (%) |
| 4-1 | Asphalt/acrylonitrile | Xylene | 3 | minutes | 24.5 |
| 4-2 | CTP/acrylonitrile | Xylene | 3 | minutes | 8.3 |
| 4-1 | Asphalt/acrylonitrile | Mineral spirits | 3 | minutes | 18.2 |
| 4-2 | CTP/acrylonitrile | Mineral spirits | 3 | minutes | 13.3 |
| 4-1 | Asphalt/acrylonitrile | Canola oil | 18 | hours | 24.5 |
| 4-2 | CTP/acrylonitrile | Canola oil | 18 | hours | 8.3 |
| 4-1 | Asphalt/acrylonitrile | Isopropyl | 18 | hours | 5.3 |
| | | alcohol (70%) | | | |
| 4-2 | CTP/acrylonitrile | Isopropyl | 18 | hours | 0.0 |
| | | alcohol (70%) | | | |

TABLE 6
Comparison of asphalt and CTP polyacrylate blends

| | | | Immersion | | Weight |
|---|---|---|---|---|---|
| Formula # | Composition | Solvent | time | | loss (%) |
| 4-3 | Asphalt/acrylate | Xylene | 3 | minutes | 31.6 |
| 4-4 | CTP/acrylate | Xylene | 3 | minutes | 12.3 |
| 4-3 | Asphalt/acrylate | Mineral spirits | 3 | minutes | 30.0 |
| 4-4 | CTP/acrylate | Mineral spirits | 3 | minutes | 5.1 |
| 4-3 | Asphalt/acrylate | Canola oil | 18 | hours | 14.3 |
| 4-4 | CTP/acrylate | Canola oil | 18 | hours | 2.6 |
| 4-3 | Asphalt/acrylate | Isopropyl | 18 | hours | 0.0 |
| | | alcohol (70%) | | | |
| 4-4 | CTP/acrylate | Isopropyl | 18 | hours | 0.0 |
| | | alcohol (70%) | | | |

TABLE 7
Comparison of asphalt and CTP neoprene blends

| | | | Immersion | | Weight |
|---|---|---|---|---|---|
| Formula # | Composition | Solvent | time | | loss (%) |
| 4-5 | Asphalt/Neoprene | Xylene | 3 | minutes | 28.0 |
| 4-6 | CTP/Neoprene | Xylene | 3 | minutes | 28.0 |
| 4-5 | Asphalt/Neoprene | Mineral | 3 | minutes | 18.0 |
| | | spirits | | | |
| 4-6 | CTP/Neoprene | Mineral | 3 | minutes | 12.5 |
| | | spirits | | | |
| 4-5 | Asphalt/Neoprene | Canola oil | 18 | hours | −20.6* |
| 4-6 | CTP/Neoprene | Canola oil | 18 | hours | −3.2* |
| 4-5 | Asphalt/Neoprene | Isopropyl | 18 | hours | 0.0 |
| | | alcohol (70%) | | | |
| 4-6 | CTP/Neoprene | Isopropyl | 18 | hours | 0.0 |
| | | alcohol (70%) | | | |

*negative values indicate undesirable weight gain due to absorption and retention of nonvolatile oil

### EXAMPLE 4

### Two Part Composition

Tall oil emulsions allow the preparation of useful coatings and membranes by the two part processes commonly used for asphalt based systems and illustrated in the introduction above. In two sequential experiments compositions 1-7 and 1-8 separately constituted ‘Part A’ of a conventional two part spray application. In both cases the curing agent, ‘Part B’, was a 10% solution of calcium chloride, the ratio of Parts A to B being 10:1.

The results of this experiment are summarized in Table 8. “Breaking pattern” describes the rate of setting on the substrate, and rapidity with which water droplets form on the surface as the curing proceeds. The sample thickness prepared was 80 dry mils (2 mm); tensile strength and elongation were determined after 28 days cure time.

TABLE 8

| | | | Tensile | | |
|---|---|---|---|---|---|
| | Breaking | Final | strength, | Elongation | Durometer |
| Formula # | pattern | appearance | psi | % | hardness |
| 1-7 | Good, | Uniform | 150 | 800 | 85 |
| | fast | flat | | | |
| | | black | | | |
| | | color | | | |
| 1-8 | Good, | Uniform | 170 | 750 | 85 |
| | fast | clear | | | |
| | | tan | | | |
| | | color | | | |

These results indicate that the physical properties of a typical polymer modified pitch composition is essentially indistinguishable from one derived using an asphaltic emulsion.

We claim:

1. A coating composition comprising a mixture of an aqueous emulsion of tall oil and an aqueous polymeric latex, the weight ratio of tall oil to polymer being between 10:90 to 95:5.

2. A coating composition according to claim 1, wherein said polymeric latex is an aqueous dispersion of a non-elastomeric plastic.

3. A coating composition according to claim 2, wherein said non-elastomeric plastic is selected from the group consisting of polyvinyl alcohol, polyvinyl acetate, polyacrylates, polymethyl methacrylate, ethylene-vinyl acetate copolymers, ethylene-acrylate copolymers and vinyl acetate-acrylate copolymers.

4. A coating composition according to claim 3, further comprising at least one additive selected from the group consisting of pigments, fillers, UV absorbers, fire resistance enhancers and viscosity modifiers.

5. A coating composition according to claim 1, wherein said polymeric latex is an aqueous dispersion of an elastomer.

6. A composition according to claim 5, wherein said elastomer is selected from the group consisting of natural rubber, gutta-percha, styrene-butadiene rubber, styrene-isoprene rubber, polyisoprene, polybutadiene, polychloroprenes (Neoprenes), organic polysulfides, butyl rubber, halogenated butyl rubber, chlorinated polyethylene, chlorosulfonated polyethylene, ethylene-propylene rubber, and butadiene-acrylonitrile copolymers.

7. A coating composition according to claim 1, wherein said aqueous emulsion of tall oil is an anionic or non-ionic emulsion of crude tall pitch and said polymeric latex comprises an elastomer selected from the group of polychloroprenes.

8. A coating composition according to claim 1, wherein said aqueous emulsion of tall oil is a 60% active anionic crude tall pitch emulsion and said polymeric latex is selected from the group consisting of styrene-butadiene co-polymer, polyacrylates, polychlorisoprene and mixtures thereof.

9. A composition according to claim 5, further comprising a pigment to impart colour to coatings prepared by the application of said composition to a desired surface.

10. A two-component sprayable waterproofing system comprising, as a first part thereof, a mixture of a tall oil emulsion and a polymeric latex and as a second part thereof an aqueous solution of a curing agent effective, when said two parts are separately sprayed through a twin-nozzle spray unit onto a surface, to effect curing of the sprayed material to a protective coating on the surface.

11. A two-part composition according to claim 10, wherein said first part comprises a mixture of a tall oil pitch anionic emulsion of a latex of neoprene, styrene-butadiene, acrylic or mixtures thereof, and the second part is an aqueous solution of an alkaline earth metal salt.

12. A two-part mixture according to claim 10, wherein said first part comprises from about 98 to about 65 weight percent of a tall oil emulsion containing from about 40 to about 70 weight percent solids, and from about 2 to about 35 weight percent of a polymer latex containing from about 55 to 65 weight percent solids.

13. A method of applying a protective coating to a surface, comprising the step of spraying the surface with a mixture of an aqueous tall oil emulsion and a polymeric latex and with an aqueous solution of a curing agent to effect curing of the sprayed material to form a protective coating on the surface.

14. A method according to claim 13, wherein said aqueous tall oil emulsion is an aqueous emulsion of crude tall pitch, said polymeric latex is a latex of polychloroisoprene and said curing agent is calcium chloride.
